(19) United States
(12) Patent Application Publication
(10) Pub. No.: US 2021/0191357 A1
(43) Pub. Date: Jun. 24, 2021

(54) METHOD FOR CONTROLLING A LEVEL OF QUALITY OF SCREWING BY A SCREWDRIVER, ASSOCIATED DEVICE AND PROGRAM IMPLEMENTING THE METHOD

(71) Applicant: ETABLISSEMENTS GEORGES RENAULT, Saint Herblain (FR)

(72) Inventor: Nicolas JOUSSET, COUERON (FR)

(21) Appl. No.: 17/126,285

(22) Filed: Dec. 18, 2020

(30) Foreign Application Priority Data
Dec. 19, 2019 (FR) 1914948

(51) Int. Cl. G05B 19/18

(52) U.S. Cl. CPC G05B 19/182; G05B 2219/45203; G05B 2219/40072

(57) ABSTRACT

A method for controlling a level of quality of screwdriving by a screwdriver relative to a predetermined screwdriving objective. Such a method takes account of a series of data that are representative of the rise in torque of at least two screwdrivings of screws at a predetermined angular frequency and includes: obtaining a sub-series of data for each of the screwdriving operations, corresponding to a sub-series of measurements delivering the sub-series of data; optimized aggregation of the sub-series, to form the series of data, including eliminating data corresponding to a number of measurements that is determined according to a criterion of optimization of periodicity; and analyzing the series of data, delivering information representative of a dispersion and/or a deviation relative to the screwdriving objective, resulting from disturbances induced by the screwdriver.

### FIELD OF THE INVENTION

The field of the invention is that of industrial toolings, and especially toolings designed to carry out a screwing operation at one or more specified torque values.

The invention relates more specifically to the control of the quality of the work performed by such toolings, for example to identify a defect or a state of wear and tear of the tool, and, if necessary, to trigger the issuing of an alert.

### PRIOR ART AND ITS DRAWBACKS

In the industrial field of motor vehicle or aircraft for example, for example, screwdriving tools are very widely used. These tools, which can be fixed or portable (and in the latter case equipped with batteries), are incorporated in motors, especially electrical or pneumatic motors depending on the applications envisaged. These tools can be connected (by radio or by wire) to a controller (which for example takes the form of a pack or box) used to manage and drive different operating cycles.

In general, the screwing operation is enslaved or automatically feedback-controlled and the tool measures the torque applied to the screw by the screwdriver. This measurement is transmitted to the controller which ascertains that its value is situated within the limits stipulated by the screwing strategy. In this way, a controller can trigger the stopping of the work when the measurement of the torque attains a threshold value. The results of the screwing operation can be recorded in quality databases for subsequent treatment and/or used by the operator to verify whether or not the tightening operation is accurate.

The controller especially ensures traceability of the operations performed by the tool, in ensuring for example the recording of the results such as the final screwing torque, the screwing speed, the final screwing angle, the date and time of operations or again the tables representing quality (good or poor depending on predetermined parameters) of the screwing operation performed.

The measurement made by the sensor equipping the tool reflects the torque applied to the screw. This measurement is impacted by different transmission elements which add a noise to the signal measured. The screwdriver comprises at least the following elements:
a motor;
one or more epicyclic gear trains aimed at augmenting the torque value produced by the motor, and
a torque sensor.

It can also include other elements, in particular an angle transmission element or angular member.

All these elements can disturb the signal from the sensor, which then no longer perfectly reflects the torque applied to the screw. This noise can for example prompt a stoppage that does not correspond to the predefined set-point value of stoppage and therefore leads to a wrong screwing operation even while the screwdriver sends back a positive report. In addition, the deterioration of the angle transmission elements can lead to an increase in noises on the measured signal. This increase in the noise reduces the performance of the tool (deterioration of precision).

It is therefore desirable to control the precision of these screwing means and the proper state of operation of the tools, whether it is for controls and/or for the tracking of the screwing parameters for the efficient execution of these parameters.

In other words, it should be possible to verify the reliability of the tools, and this must be done regularly throughout the duration of use of the tools, so as to be able to carry out maintenance, preferably preventive maintenance. It is thus sought to prevent or at any rate reduce especially states of wear and tear leading to poor quality of screwing and/or breakage of tools on the assembly line, making it necessary to halt this line in order to replace the tool. This of course lowers the overall productivity of the assembly line concerned.

There are known ways of applying preventive maintenance which consists in counting up the number of uses of the tool (number of screwing operations or total time of use) and comparing the value of the counter with recommendations put out by the tool providers, these recommendations being expressed by a periodicity of servicing. These methods entail an empirical approach which provides a statistical estimation of the wear and tear of a tool but does not really give its actual state.

There are also known ways of carrying out regular controls on a test bed. These controls require a stoppage of production, the tool being shifted to the test bed, generally in a site distinct from the production site. This slows down production and/or leads to the implementing of replacement tools.

The ISO5393 standard thus stipulates the performance of at least 25 test screwing operations to control a screwing tool.

The controls can be carried out in different ways. For example, the document FR2882287 describes a screwing tool comprising a rotating element mounted on a body and a tightening torque measuring sensor. The measurement of the torque provides data used to determine the state of wear and tear of the elements. More specifically, this document teaches the processing of a spectrum of frequencies in order to extract at least one vibrational frequency associated with a rotating element; this frequency is then compared with a reference frequency with a view to determining the state of wear and tear of the rotating element considered.

This makes it possible to identify possible defects in the screwdriver but not a level of tightening precision.

There is therefore, depending on the applications and/or the tools:
a need to implement a technique for controlling the operation of a screwing tool in order to determine whether the work performed falls within a determined range of parameters, or in other words, for controlling the working quality, without introducing any interruption of the production,
a need for such a determination to be precise,
a need to provide an alert to warn the user in real time about the incapacity of the tool to accurately carry out the screwing operation, for example during the use of a screwdriver on an assembly line and/or
a need to speedily provide an estimation of the dispersion and of the deviation relative to a tightening objective. This means doing so more rapidly and more simply than with the tests currently performed (for example according to the ISO5393 standard).

A method providing a response to at least some of these needs is described in the patent application FR1860400 (not published). However, this technique, described in greater detail here below, can be difficult to implement in practice. It requires the performance of measurements on a sufficient angular range, for example of the order of 720°, which is often greater than the angle covered by a single screwing operation. It is proposed to concatenate several screwing operations to attain a sufficient angular range. However, in practice, it is not possible to directly concatenate measurements coming from several screwing operations: the method calls for the availability of data representative of a signal with a periodicity sufficient to carry out the processing operations efficiently.

The present invention is aimed especially at providing a simple and efficient solution to this requirement.

### SUMMARY OF THE INVENTION

One embodiment of the invention proposes a method for controlling a level of quality of screwing by a screwdriver relative to a predetermined screwing objective or target. Such a method takes account of a series of data that are representative of the rise in torque of at least two operations for screwing screws at a predetermined angular frequency. The method of control comprises the following steps:
obtaining a sub-series of data for each of the screwing operations, from a corresponding sub-series of measurements;
optimized aggregation of the sub-series to form the series of data, comprising a step of elimination of data corresponding to a determined number of measurements according to a criterion of optimizing periodicity; and
analysis of the series of data, delivering said at least one piece of information representative of a dispersion and/or a deviation relative to the screwing objective or target, resulting from disturbances induced by the screwdriver.

In embodiments, the method of control comprises the following steps:
obtaining, at a predetermined angular frequency, of the series of doublets that is representative of the rise in torque of the screwing of at least one screw screwed in by the screwdriver, constituting a first table of values, each doublet comprising an angle value and a torque value;
determining, from the first table of values, of a second table of values presenting the torque as a function of the angle, and representative of the true characteristic of the at least one screw;
determining a third table of values presenting the torque as a function of the angle and representative of the disturbances induced by the screwdriver during the rise in torque of the screwing of at least one screw, on the basis of the first and second tables.

The steps for obtaining a series of doublets, for determining a second table and for determining a third table are implemented for at least one first screwing and one second screwing of screws by the screwdriver, delivering at least two corresponding third tables, called third unit screwing tables. The method of control comprises a step of optimized aggregation of at least two third unit screwing tables comprising a step of elimination, in at least one of the third unit screwing tables, of a number of values that is determined according to a criterion of optimization of periodicity, the step of optimized aggregation delivering a third candidate aggregated table. The method of control comprises a step of analysis of a third aggregated table taking account of the third candidate aggregated table, delivering at least one piece of information representative of a dispersion and/or a deviation relative to the screwing objective or target, resulting from disturbances induced by the screwdriver.

Thus, the invention is used to determine parameters representative of a disturbance (related for example to the engaging or meshing of gear teeth, electrical disturbances of signals, etc.) on the basis of at least two screwing operations. Such a disturbance is characterized especially by an oscillation of the signal about its real value, at variable frequencies and amplitudes. With the disturbance being known, it is thus possible to determine values of dispersion of the tool as well as calibration defect resulting from this disturbance. Besides, the present technique enables a precise determining of the values in question. The optimized aggregation indeed enables an analysis of the measurements on a duration that is lengthier and therefore ultimately a better resolution of analysis.

It is also possible to compute what would be the dispersion and/or the deviation relative to the objective or target on a screw having a stiffness other than the one on which the screwing operation has been performed. These values make it possible to speedily determine whether or not the tool is still capable of carrying out the work under the requisite conditions and, if necessary, of triggering a warning signal to repair or to change it.

The approach of the invention is not only faster but it also enables above all a real-time and direct on-the-assembly-line processing, contrary to the prior-art solutions.

The term “table” refers in the present description and in the claims to sets or series of doublets of values of the (x, y) type. These sets can, if necessary, be represented and/or registered in different forms (data tables, equations, etc.).

In embodiments, the step of optimized aggregation comprises a concatenation, on the one hand, of a third table of the first screwing operation and, on the other hand, of a truncated version of a third table of the second screwing operation, called a third truncated table, delivering an intermediate aggregated table. The third truncated table results from an elimination, in the third table of the second screwing operation, of a given number of successive values corresponding to angles of minimal amplitude among the values of the third table of the second screwing operation. The elimination, in the third table of the second screwing operation, and the concatenation repeated for different values of the given number deliver a set of intermediate aggregated tables comprising the third candidate aggregated table.

In embodiments, the step of optimized aggregation comprises a concatenation, on the one hand, of a truncated version of a third table of the first screwing operation, called a third truncated table and, on the other hand, a third table of the second screwing operation, delivering an intermediate aggregate table. The third truncated table results from an elimination, in the third table of the first screwing operation, of a given number of successive values corresponding to angles of maximum amplitude among the values of the third table of the first screwing operation. The elimination in the third table of the first screwing operation and the concatenation repeated for different values of the given number deliver a set of intermediate aggregated tables comprising the third candidate aggregated table.

Thus, different combinations of concatenation of the two third tables are obtained with, for each combination, an elimination of a different number of values at the beginning of the third table associated with the second screwing operation.

In embodiments, the step of optimized aggregation comprises:
a self-correlation of each intermediate aggregated table of the set of intermediate aggregated tables delivering a corresponding set of self-correlated intermediate aggregated tables; and
an averaging of each of the self-correlated intermediate aggregated tables delivering a corresponding set of averaged values.

An intermediate aggregated table, the corresponding averaged value of which is maximum among the averaged values, is selected as being the third candidate aggregated table according to the criterion of optimizing of periodicity.

Thus, the third candidate aggregated table corresponds to the intermediate aggregated table having the greatest regularity (as understood in terms of self-correlation) among the different tables of the set of intermediate aggregated tables. This means that the results of an analysis based for example on an implementation of a Fourier transform are improved, the discontinuities of the analyzed table being minimized.

In embodiments, when several intermediate aggregated tables, called candidate intermediate aggregated tables, have an averaged value of a same maximum value among the averaged values, an intermediate aggregated table corresponding to the elimination of a minimum number of successive values, during the implementation of the elimination in the third table of the second screwing operation, is selected from among the candidate intermediate aggregated tables as being the third candidate aggregated table according to the criterion of optimization of periodicity.

Thus, a maximum number of values is obtained in the third candidate aggregated table so as to enable a better resolution of analysis of the table in question.

In embodiments, the step of optimized aggregation comprises:
a correlation between, on the one hand, the third table of the first screwing operation and on the other hand the third table of the second screwing operation delivering a correlation function; and
a determining of at least one angle value maximizing the correlation function.

The criterion of optimization of periodicity corresponds to the elimination, in the third table of the first screwing operation, of a number of successive values, called an optimized number, taking account of a value of an angle among the value or values of angles maximizing the correlation function.

Thus, the third aggregated table is ultimately obtained with a borderline number of computations.

In embodiments, when several angle values maximize the correlation function, the optimized number is a function of a maximum value of an angle among the values of angles maximizing the correlation function.

Thus, a maximum number of values is obtained in the third aggregated table so as to enable a better resolution of analysis of the table in question.

In embodiments, the step of optimized aggregation comprises a concatenation, on the one hand, of a truncated version of the third table of the first screwing operation, called the third truncated table and, on the other hand, the third table of the second screwing operation, the concatenation delivering a third candidate aggregated table. The third truncated table results from an elimination, in the third table of the first screwing operation, of the optimized number of successive values corresponding to angles of maximum amplitude among the values of the third table of the first screwing operation.

Thus, the optimized concatenation of the two third tables is obtained via an elimination, at the end of the third table associated with the first screwing operation, of a number of values equal to the optimized number.

In embodiments, the method of control comprises a test of the total number of values of the third candidate aggregated table. It is decided that the third candidate aggregated table is the third aggregated table when the total number of values of the third candidate aggregated table is above a predetermined threshold.

Thus, the number of values of the third aggregated table is sufficient to be able to obtain an efficient resolution of analysis of the defects of the screwdriver.

In embodiments, the method of control comprises, when the total number of values of the third candidate aggregated table is below the predetermined threshold:
a new implementation of the steps for obtaining a series of doublets, for determining a second table and for determining a third table for a new screwing of screws by the screwdriver, delivering a corresponding new third table; and
a new implementation of the step of optimized aggregation between the third candidate aggregated table and the new third table, delivering a new candidate aggregated table.

Thus, when the number of values of the third aggregated table is not enough to be able to carry out a fine analysis of the defects of the screwing operation, a new optimized aggregation is performed in order to obtain a sufficient number of values.

The invention also relates to a computer program comprising program code instructions for implementing the method of control described here above (according to any one of the different embodiments mentioned here above) when it is executed on a computer and/or by a microprocessor. The invention also concerns a screwdriver comprising means configured to implement the method of control described here above (according to any one of the different embodiments mentioned here above).

Thus, the characteristics and advantages of this screwdriver are the same as those of the method described here above. They are therefore not described in more ample detail.

According to another approach, for example when the tool does not have available sufficient processing power, all or part of the method can be implemented in a hub or a server with which the tool communicates. In this approach, the measurements are made by the tool and then transmitted to the hub or to the server which carries out the different operations of the control method.

### LIST OF FIGURES

Other aims, features and advantages of the invention shall appear more clearly from the following description, given by way of a simple, illustratory and non-exhaustive example with reference to the figures, of which:

FIG. 1 is a view in section of a tool integrated into a tooling set according to the invention;

FIG. 2 is a functional diagram of a tooling set according to the invention;

FIG. 3 presents, in an exemplary diagram, the variations of tightening torque as a function of the number of tightening operations performed by one and the same tool;

FIG. 4 presents a flowchart of the main steps for implementing a method for controlling a level of quality according to a first implementation;

FIG. 5a presents an example of a linear characteristic of a given stiffness, according to the first implementation;

FIG. 5b presents an example of a curve representative of the first relationship, according to the first implementation;

FIG. 5c presents an example of a curve representative of the second relationship, according to the first implementation;

FIG. 5d presents an example of a curve representative the third relationship, according to the first implementation;

FIG. 6a presents an example of a curve representative of the first table, according to a second implementation;

FIG. 6b presents an example of a curve representative of the second table, according to a second implementation;

FIG. 6c presents an example of a curve representative of an intermediate table, illustrating the fact that the tool always stops at the level of a maximum value, according to the second implementation;

FIG. 6d presents an example of a curve representative of the third table, according to the second implementation;

FIG. 7 presents a flowchart of the main steps for the implementation of the method of control of a level of quality according to a first embodiment of the invention;

FIG. 8a presents an example of two curves representative of two first tables obtained for two screwings of screws by the screwdriver of FIG. 1, according to the first embodiment;

FIG. 8b presents an example of two curves representative of two third tables corresponding to the two curves of FIG. 8a, according to the first embodiment.

FIG. 8c presents an example of curves representative of a set of intermediate aggregate tables obtained from the two curves of FIG. 8b, according to the first embodiment;

FIG. 9 presents a flowchart of the main steps for the implementing of the method of control of a level of quality according to a second embodiment;

FIG. 10a presents an example of truncated version of a curve representative of the third table obtained for a first screwing of screws by the screwdriver of FIG. 1, according to the second embodiment;

FIG. 10b presents an example of an offset version of a curve representative of the third table obtained for a second screwing of screws by the screwdriver of FIG. 1, according to the second embodiment;

FIG. 10c presents an example of a curve representative of the third candidate aggregate table obtained by optimized concatenation of the curves of FIG. 10a and of FIG. 10b, according to the second embodiment.

### DETAILED DESCRIPTION OF EMBODIMENTS OF THE INVENTION

In all the figures of the present document, the identical elements and steps are designated by same references.

The general principle of the technique described relies on the computation of what would be the dispersion of a screwing tool or screwdriver and its mean standard deviation relative to the tightening target or objective on the basis of the disturbances detected in the signal produced by its torque sensor. More specifically, the invention relates to a technique for implementing the technique described in the patent application FR1860400, not published, and presented here below (§ 5.3), making it possible to take account of at least two series of measurements corresponding to distinct screwing operations.

### 5.1 Example of a Tool Implementing the Technique of the Invention

Referring to FIG. 1, a screwing tool according to the present embodiment comprises a motor 1 mounted in the body 10 of the tool, the motor output being coupled to a gearing or reduction gear 2 formed by epicyclic gear trains, itself coupled to an angle transmission gearing 3 (the screwing axis is herein perpendicular to the drive axis; the angle transmission gearing 3 can be absent in the event of another embodiment that can be envisaged, according to which the screwing axis and the motor axis are coaxial) intended to rotationally drive a screw head having a bit 4 designed to receive a screw bush.

In a manner known per se, a torque sensor 51 (for example a bridge of strain gauges) delivers information on the tightening torque exerted by the tool. An angle sensor 52 is also provided in the rear of the motor. It can for example comprise a magnet rotating before a Hall-effect sensor carried by an electronic board.

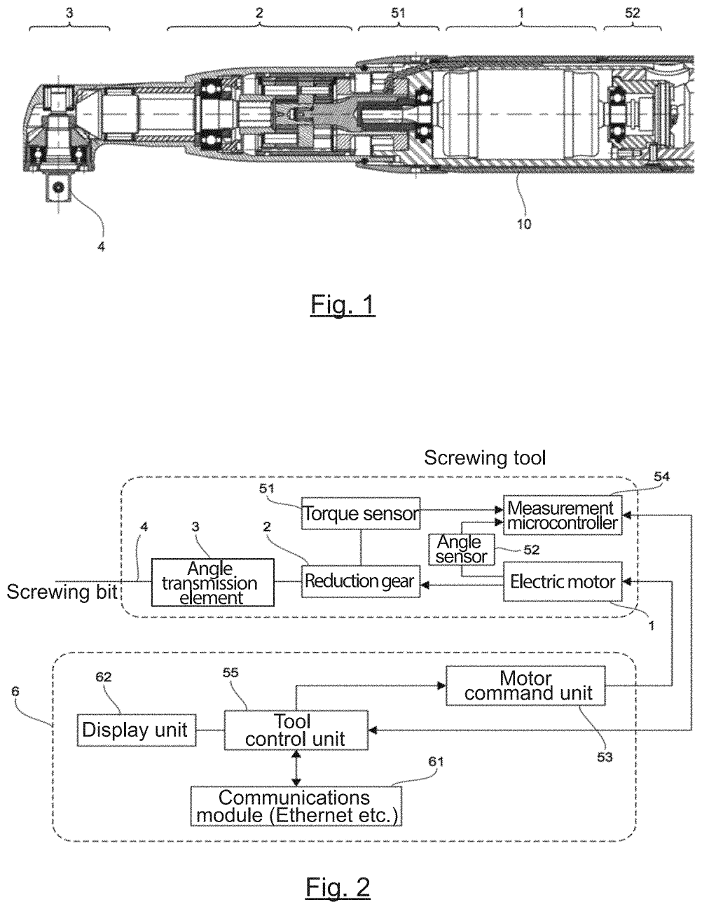

In the functional diagram of FIG. 2, the mechanical elements are this time represented in schematically so as to show the motor 1, the reduction gear 2 and the angle transmission element 3. As illustrated, the torque sensor 51 is connected to a measurement microcontroller 54 which transmits the data to a control unit 55 of the tool.

Depending on the data given by the torque sensor 51, a control unit 55 drives the operation of the motor 1 by means of a command unit 53.

The control unit 55 furthermore incorporates means for processing the signal given by the torque sensor 51 to deliver at least one piece of information representative of a dispersion and/or of a deviation relative to said screwing objective, resulting from disturbances generated by the screwdriver.

According to the present embodiment, the control unit 55 and the command unit 53 are integrated into a unit 6, designated by the term “screwing controller” in FIG. 2.

The screwing controller 6 comprises or may be formed by a microprocessor or microcontroller, implementing a program, stored in an internal or external memory, allowing in particular to execute the steps of the process of the invention, for example according to the modes of realization described hereafter. It can also integrate or control:
a communications module 61 enabling the connection of the controller 6 to an information exchange network, for example of the Ethernet type;
a display unit 62.

Thus, when the controller 6 detects that the value of dispersion or deviation relative to the set-point value no longer meet production requirements, a warning signal and/or message is displayed on the display unit 62, and, if necessary, sent to a remote station by means of the communications module.

In the case of a battery-operated tool, the control functions of the tool 55 and the command functions of the motor 53 can be integrated into the tool.

According to one embodiment, such a message can indicate the defective element concerned, for example by comparison of the individual dispersion with threshold values or a percentage of the dispersion, and can also specify the type of maintenance and/or servicing work to be performed.

It may be recalled that the screwing torque is determined on the basis of a voltage transmitted by the torque sensor 5.

### 5.2 Control of a Level of Quality of the Screwing

After having given details by examples of the main devices for the implementing of the invention, we shall now explain how these devices cooperate in the context of a method of control of a level of quality of screwing by a tool.

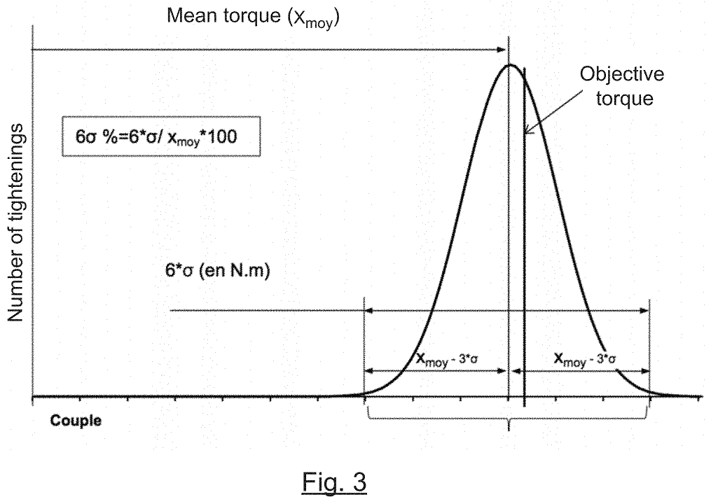

The curve of FIG. 3 illustrates the variations of tightening torque as a function of the number of tightening operations measured. This curve is prepared on the basis of several measurements (for example 25 to 100) enabling the performance of statistical studies on the behavior of a tool. The exploitation of the results especially gives the following two pieces of data:
the dispersion of the tightenings of the tool, characterized by a mean standard deviation (σ), providing information on the capacity of the tool to reproduce a torque value with precision. The dispersion is generally expressed as six times the mean standard deviation divided by the mean in percentage;
the deviation relative to the objective, evaluated by computing the difference between the mean and the objective, divided by the objective. The preliminary calibration of the screwdriver relative to the objective is aimed at having the smallest possible deviation.

The measurement curve typically has the shape of a Gaussian curve, the quasi-totality of the tightening operations (99.73%) in the test performed being situated in the 6σ zone.

To accurately estimate the precision of the tool during a single screwing operation (or on a borderline number of tightening operations) it is necessary that all the defects should be present on the torque curve. Now a defect that occurs once per turn of an output shaft of the screwdriver will not necessarily appear if the screwdriver needs a 30° rotation in order to be tightened. A minimum angle of rotation by 720° (at least two turns to analyze the low frequencies) of the output shaft is desirable (obtained on one screwing operation or, according to the present invention, several screwing operations).

The disturbances prompting variations of torque from one screwing operation to another have various origins such as the meshing or engagement of the gear teeth or again electrical disturbances of the signals by the magnetic field of the motor which generate deviations between the measurement of the torque and the torque actually applied to the screw.

These disturbances are characterized by an oscillation of the measurement of the torque of the tool about what would be the value really applied to the screw if it were to be measured in real time by a sensor placed between the screw and the screwdriver.

This oscillation occurs at variable frequencies and amplitudes depending on the origin of the disturbances.

In the context of the present description, it is assumed that the amplitude of the disturbances is proportional to the instantaneous torque provided by the screwdriver. This has the consequence wherein the dispersions and deviations are of the same level whatever the tightening torque.

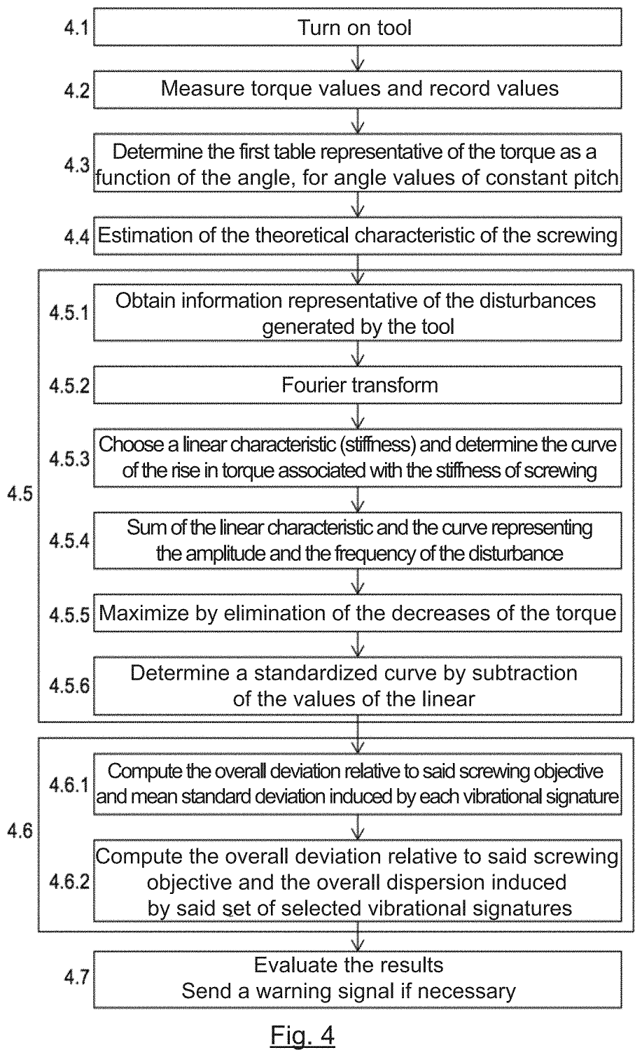

According to the estimation results, the method that is the object of the invention comprises a step for sending a warning signal when the controller 6 detects that the dispersion or deviation relative to this set-point value of the tightenings no longer meets production requirements. This alert responds to quality constraints but also security constraints. An alert can also be generated during the detection of an abnormal amplitude of disturbance of a component, with a view for example to carrying out a diagnostic. This can especially be rendered in the form of a table presenting the dispersions and the deviations for each disturbance, as explained in greater detail here below, with reference to the step 4.7 of the method of FIG. 4.

It is also possible, during a maintenance test, to estimate the dispersion and deviation of the set-point value of the tightenings of the screwdriver for usual test stiffness values, thus enabling a rapid control of the tool.

It can be noted that this estimation does not take account of certain effects of the screwdriver such as insufficient braking of the motor when the tightening objective is attained. It is in fact not easy and hardly necessary to determine what happens after the motor stops.

One of the aspects of the invention consists in computing what would be the dispersion of a screwdriver tool and its mean deviation relative to the tightening objective from the disturbances detected on the signal produced by its torque sensor 51. This evaluation can be carried out during a single tightening operation performed on a production line for example. This evaluation is therefore far more rapid than the one consisting in carrying out a diagnostic generally requiring several tens of tightening operations on a test bed.

Examples of processes of the invention, which can be implemented on a microprocessor and/or in a computer, are described below.

### 5.3 Examples of a Screwing Control Method

### 5.3.0 Glossary

In the context of the present description and of the claims:
“first table” is a table of doublets each comprising an angle value and a torque value. Such a first table is representative of the rise in torque of the screwing of a screw;
“second table” is a table containing a series of values representative of the true characteristic of the screw as a function of the angular pitch;
“third table” is a table of values presenting the torque as a function of the angle. Such a third table is representative of the disturbances induced by the screwdriver during the rise in tightening torque;
“third unit screwing table” is a third table obtained from a given screwing operation. At least two third unit screwing tables are taken into account: these are called a third table of a first screwing operation and a third table of a second screwing operation, according to the method according to the invention;
“third truncated screwing table” is a third unit screwing table from which data relative to one or more measurements are eliminated;
“third intermediate table” is a third table containing data coming from at least 2 third unit screwing tables and/or third truncated screwing tables;
“third aggregated table” is a third table containing data coming from at least 2 third unit screwing tables and/or third truncated screwing tables comprising a number of values considered to be sufficient to carry out an analysis of the disturbances induced by the screwdriver;
“third candidate aggregated table” or “third selected aggregated table” is a third table selected from among at least two “third aggregated tables” according to a criterion of optimization.

### 5.3.1 First Implementation of a Method for Controlling a Screwing Operation

Referring to FIG. 4, a first implementation shall now be described. FIG. 4 presents a flowchart of the main steps for the implementing of a method of control of a level of quality of screwing of a screwdriver, relative to a predetermined screwing objective, according to a first example of an embodiment.

At the step 4.1, the tool, a screwdriver for example, is put into operation and carries out a job according to a screwing strategy for example. During the task, the sensors measure the value of the torque (sensor 51) and the angle (sensor 52) in referencing these measurements in relation to time. The measurements are taken every millisecond for example (step 4.2). The values from the sensors 51 and 52 are transmitted to the controller 6.

The controller 6 memorizes the values of the measurements and processes them in order to produce a table of doublets of torque values and angle values as a function of time, for example at predetermined time intervals. This table is called a “rough table”. At the step 4.3, the controller determines a table representative of the torque as a function of the screwing angle, for angle values of constant pitch, to prepare a first table of doublets representative of the rise in torque of the screwing of at least one screw, each doublet comprising an angle value and a torque value. The step consists in:
determining (I) an angular pitch, which can be chosen arbitrarily and can, for example, correspond to a mean pitch situated between two values. It corresponds in the latter case to the deviation between the final angle and the initial angle divided by the number of points between the two:

$$Δ θ = \frac{{θ}_{n} - {θ}_{0}}{n}$$

Thus, each new angle is computed as follows:

θ′ᵢ=i×Δθ;
Compute (II) the torque samples for each new defined angle. To carry out this second computation (II), according to a first approach, this computation can implement a linear interpolation between two torque values of the first series:

$${C}_{i}^{′} = {C}_{i} + \frac{( {C}_{i + 1} - {C}_{1} ) \times ( {θ}_{i}^{′} - {θ}_{i} )}{{θ}_{i + 1} - {θ}_{i}}$$

Other approaches, especially by polynomial interpolation of the first series of measurements, can also be used.

At the end of the step 4.3, the controller 6 sets up a series of values 51 which represents the value of the torque as a function of the angular pitch (each torque value being computed for constant angular pitch values).

We thus obtain the first table, representative of the relationship:

C_{capteur}=f(α)

obtained from doublets representative of the rise in torque value of the screwing of at least one screw, recorded in the first table (“capteur” means “sensor”). This first table makes it possible to remove any dependence on the speed of rotation of the tool which can vary during the screwing operation.

At the step 4.4, the theoretical characteristic of the assembly is estimated. This step determines an image of the true characteristic of the screw in computing a theoretical characteristic.

Several methods of digital processing (filtering) are possible such as:
linear regression applied to the table of torque values as a function of the angle.
polynomial regression applied to the table of torque values as a function of the angle.
low-pass filter having as its cut-off frequency the default value having the lowest frequency. This method enables the payload part of the disturbances to be preserved in eliminating especially possible defects of the screw, which may be not linear.

At the end of this step, the controller 6 updates a second table containing a series of values S2 representative of the true characteristic of the screw as a function of the angular pitch (at constant angle pitch). This series of values can be expressed by the formula:

C_{caractéristique vraie}=g(α)

(“caractéristique vraie” means “true characteristic”)

At the step 4.5, the part of the signal resulting from the disturbances generated by the tool can be at this instant isolated and quantified. According to one implementation, this step can be broken down into several sub-steps:

1°] The step 4.5.1 consists in choosing from the first table only the pieces of information representative of the disturbances generated by the tool.

For the same angle, the torque values of said second table are subtracted from the corresponding torque values of the first table. The result of these subtractions is divided by the corresponding torque values of the second table, this value being expressed in percent.

ΔC %=(f(α)−g(α))/g(α)

We thus determine the values of the third table.

In a second stage, at the step 4.5.2, the discrete Fourier transform is computed on this table in order to carry out a frequency analysis of the signal and reveal the different disturbances which appear in the form of a line characterized by a certain frequency. The table below presents an example of the values representative of the frequency and amplitude of each disturbance detected.

| Disturbance | Frequency | Amplitude |
|---|---|---|
| 1 | f1 | A1 |
| 2 | f2 | A2 |
| — | — | — |
| N | fn | An |

n varies for example from 1 to 1000.

It can be noted that, according to this mode of computation, the errors are considered to be independent of the torque or have little influence on its value.

2°] At the sub-step 4.5.3, a linear characteristic having a determined stiffness is chosen. This stiffness is an input parameter defined normatively, for example: sharp angle (30°)—elastic angle (360°), or between the two (in particular, this characteristic can be the true characteristic of the real assembly, defined by the second table). The tightening angle to be simulated αᵥᵢₛ (“vis” means “screw”) is selected.

The dispersion is evaluated for each frequency fi present in the above table. The table for the rise in torque as a function of the angle associated with this stiffness is expressed as follows:

$${T}_{R} ( α ) = \frac{α}{{α}_{vis}} \cdot {C}_{consigne} \\ ( α vis = α screw ; Cconsigne = Csetpoint value )$$

where:
T_{R} is the torque of the linear characteristic,
αᵥᵢₛ is the total angle of the screwing operation (from 0% to 100% of the torque in degrees),
C_{consigne} is the setpoint value torque (in Nm) (“consigne” means “set-point value”).

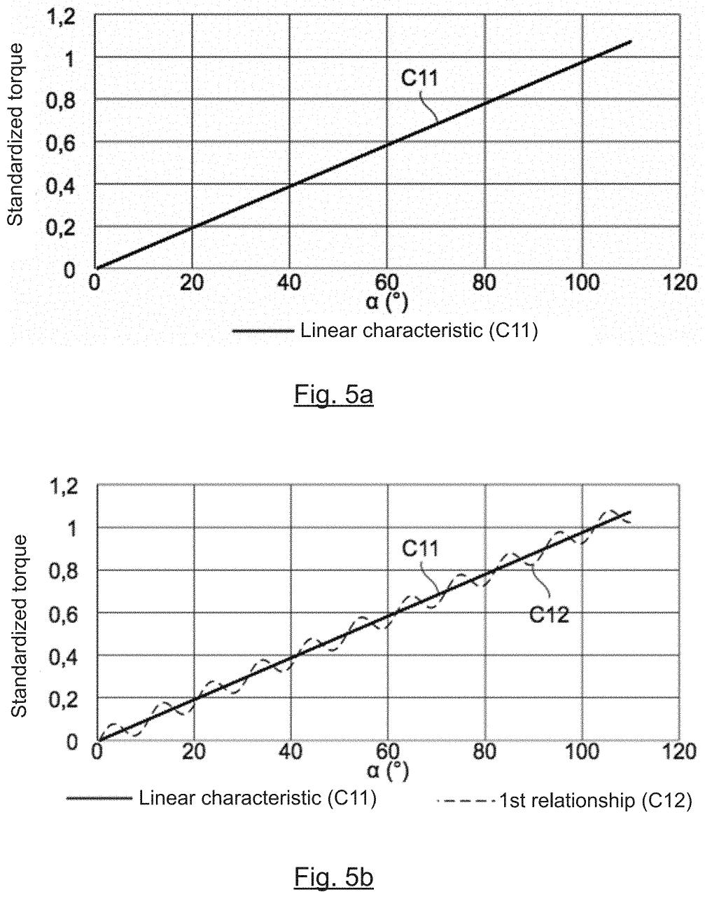

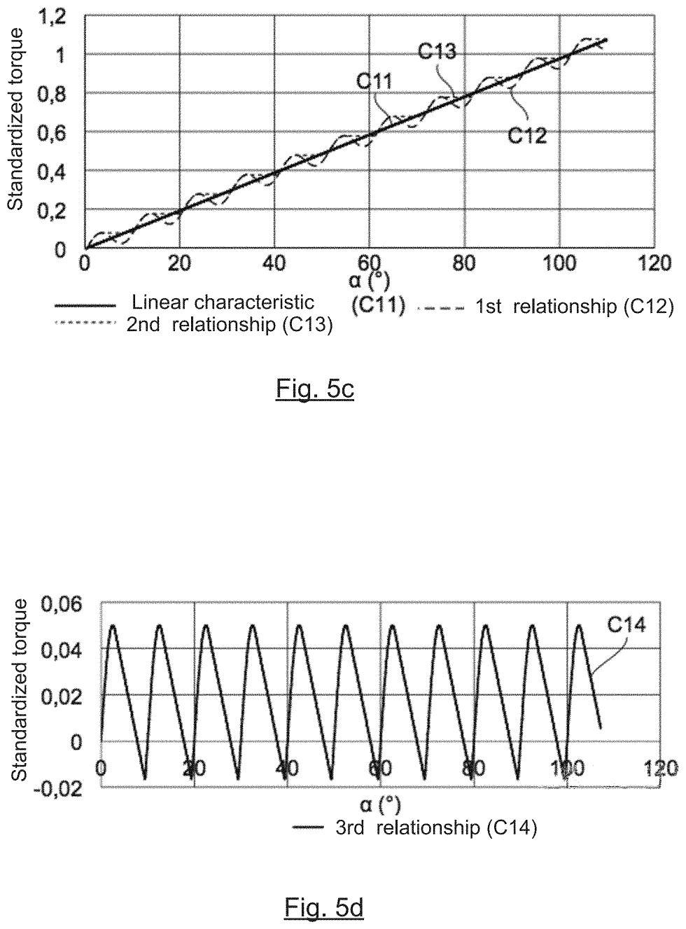

In this implementation, the real torque is considered to be perfect, i.e. the torque increases proportionally with the angle (FIG. 5a). The curve C11 illustrating this linear characteristic is a straight-line segment, the slope of which is a function of the tightening angle.

3°] At the sub-step 4.5.4, the controller 6 determines a first mathematical relationship T_{c} obtained by the sum of the curve C11 (the linear characteristic) and the sine curve, of which the amplitude and the frequency are those of the disturbance considered. The computation of this relationship of addition of the sine curve is implemented for each disturbance.

This expresses a first relationship:

T_{c}(α)=T_{R}(α)+C_{consigne}·A·sin(2·π·f·α)

where:
T_{c} is the torque measured by the sensor 5 (in Nm),
A is the relative amplitude of the defect in relation to the setpoint value torque C_{consigne} derived from the FFT (%),
f is the frequency of the disturbance (deg-1).

An example of a curve C12 produced by this first mathematical relationship is presented at FIG. 5b.

4°] At the sub-step 4.5.5, the controller 6 determines a second mathematical relationship, which expresses the fact that the stoppage of the tool does not take account of the decreases in torque. This second relationship Tₛ flows from the first relationship and is expressed as follows:

$${T}_{S} ( α ) = {max }_{0 \leq x \leq α} {T}_{c} ( x )$$

The torque values are maximized so as to eliminate the decreases, thus producing a second relationship expressing a torque as a function of an angle. In other words, Tₛ is a fictitious representation of a torque value that increases constantly, i.e. for which the stoppage of the tool cannot be activated on a torque value below a value previously attained during the job. According to this fictitious representation, the stopping of the tool does not take place during a reduction of the torque but during the attaining of a “maximum” value.

An example of a curve C13 illustrating this second mathematical relationship is presented in FIG. 5c.

5°] During the sub-step 4.5.6, the controller 6 deduces, from this second relationship, a third relationship which corresponds to a subtraction, from the values obtained by means of the second relationship, of the corresponding values of the linear characteristic. This third relationship is expressed mathematically as follows:

Tₛ(α)−T_{R}(α)

The table thus obtained is illustrated by the curve C14 of FIG. 5d.

Thus, at the end of the five steps 4.5.1 to 4.5.6, which are described here below according to one exemplary embodiment, the controller 6 can determine the dispersion and/or the deviation relative to the objective resulting from each disturbance generated by the tool (step 4.6).

In a first stage, at the step 4.6.1, the controller 6 evaluates the individual influence of the disturbances on the dispersion and/or the deviation of screwing relative to the objective.

According to one particular case, when the linear characteristic is selected at the step 4.5.3, the computation of the dispersion and of the deviation relative to the objective is done in considering an assembly stiffness that can be chosen independently of the stiffness of the assembly on which the values of the first series were collected. According to one alternative embodiment, several computations of dispersion and deviations are performed using several stiffness values, for example the standardized stiffness values used to define a sharp assembly and an elastic assembly and a stiffness proper to the application.

During the computation of the dispersion and deviation relative to the objective, the disturbances caused by the tool are considered one by one so as to evaluate, for each disturbance, its contribution to the overall disturbance.

According to one implementation, the evaluation of the individual influence of the disturbances on the dispersion and the deviation of screwing relative to the objective is done at the end of the following steps:
computing the mean of this difference over a period. This mean is representative of the divergence between the torque generated by the tool and the tightening torque objective. It is expressed as follows:

$$\overline{x} = {C}_{consigne} - f {\int }_{0}^{\frac{1}{f}} ( {T}_{S} ( α ) - {T}_{R} ( α ) ) d α$$

computation of the mean standard deviation of this third relationship. This standard deviation represents the dispersion introduced by the line on the torque generated by the tool. It is expressed as follows:

$$σ = \frac{1}{\overline{x}} \times \sqrt{{\int }_{0}^{\frac{1}{f}} {( {T}_{S} ( α ) - ( {T}_{R} ( α ) - {C}_{consigne} + \overline{x} ) )}^{2} d α}$$

These computations are repeated for each value of n (most of the values are close to 0, and not significant). The highest values correspond to possible defects. With the characteristic frequencies of each element of the tool being known, it is possible to determine the defective element or elements).

In a second stage, at the step 4.6.2, the controller 6 evaluates the influence of the set of disturbances on the dispersion and the deviation of screwing relative to the objective, in doing so for the stiffnesses or stiffness values of assembly chosen here above.

According to one exemplary embodiment, the computation is done in carrying out the following computations:
the averages are added up, and the value thus computed represents the deviation between the torque generated by the tool and the tightening torque objective for all the lines and therefore the disturbances induced by the tool. It is expressed as follows:

$${x}_{moy} \geq {C}_{consigne} - {\sum }_{i = 1}^{n} ( {\overline{x}}_{i} - {C}_{consigne} )$$

With i varying from 1 to n, i representing each of the disturbances.
the mean standard deviations are aggregated to give a value representative of the dispersion induced by the set of lines. It is expressed as follows (formula 1):

$$6 σ \leq \sqrt{{\sum }_{i = 1}^{n} {( 6 {σ}_{i} )}^{2}}$$

Indeed: σ_{X+Y}=\sqrt{σ_{X}_{²}+σ_{Y}_{²}+2σ_{X}σ_{Y}ρ(X,Y)}

### Now: −1≤ρ(X,Y)≤1

Therefore: σ_{X}_{²}+σ_{Y}_{²}+2σ_{X}σ_{Y}ρ(X,Y)≤α_{X}_{²}+σ_{Y}_{²}+2σ_{X}σ_{Y}
Knowing that: σ_{X}_{²}+σ_{Y}_{²}+2σ_{X}σ_{Y}=(σ_{X}+σ_{Y})²
We obtain: σ_{X+Y}≤\sqrt{σ_{X}_{²}+σ_{Y}_{²}}

This computation (formula 1) therefore makes it possible to verify the presence of an increase of the dispersion by the sum of the square of the dispersions computed for each defect.

According to one particular implementation and by security, the value obtained is increased relative to the real value.

At the step 4.7, tests are performed in order to determine whether the dispersion and the deviation are situated in the acceptable range and, if not, an alert is sent out. The results can be delivered in a table of the following type:

| | Dispersion | | Deviation | |
|---|---|---|---|---|
| Angle | Evaluation | Threshold | Evaluation | Threshold |
| 30° | σ₃₀ | | x̅₃₀ | |
| 360° | σ₃₆₀ | | x̅₃₆₀ | |
| Special | σ_{special} | | x̅_{special} | |
| angle | | | | |

Using such a table, it is possible to extract the dispersion and deviation for a given angle (case of a diagnostic, for a desired application of the client, an analysis is made for a given angle. This makes it possible to identify a defective component if any).

The following table presents the values of dispersion and deviation for each disturbance:

| | Dispersion | | Deviation | |
|---|---|---|---|---|
| Disturbation | Evaluation | Threshold | Evaluation | Threshold |
| 1 | σ₃₀ | | x̅₁ | |
| 2 | σ₃₆₀ | | x̅₂ | |
| — | — | | — | |
| n | σ_{special} | | x̅ₙ | |

This table can be used to identify components generating abnormal imprecision, each of the disturbances 1 to n being associated with one of these components.

The exemplary embodiment of the method for controlling a level of quality of the work of a tool that has just been described in the above pages is considered to be the most precise.

Another implementation shall now be described in the form of another example. This implementation describes a method that is simpler but appreciably less precise.

### 5.3.2 Second Implementation of a Method for Controlling a Screwing Operation

This other implementation does not integrate any FFT computation and therefore does not lay down particular conditions on the recording of the torque table.

In a first stage and in a manner identical to the first implementation, the torque table expressed as a function of the angle is computed and recorded. The result of this step is a series of values forming the first table, and expressing:

C_{capteur}=f(α)

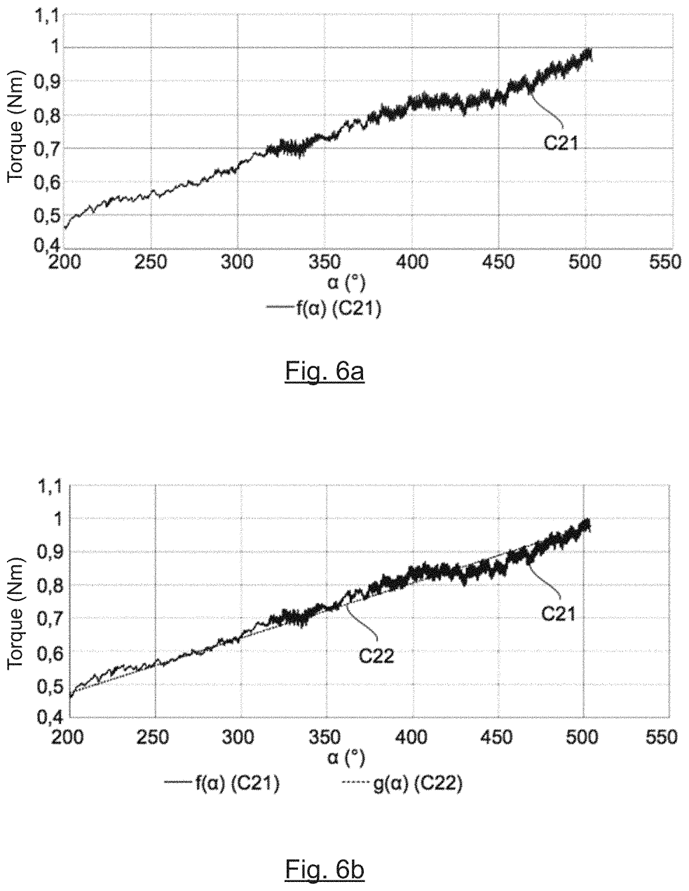

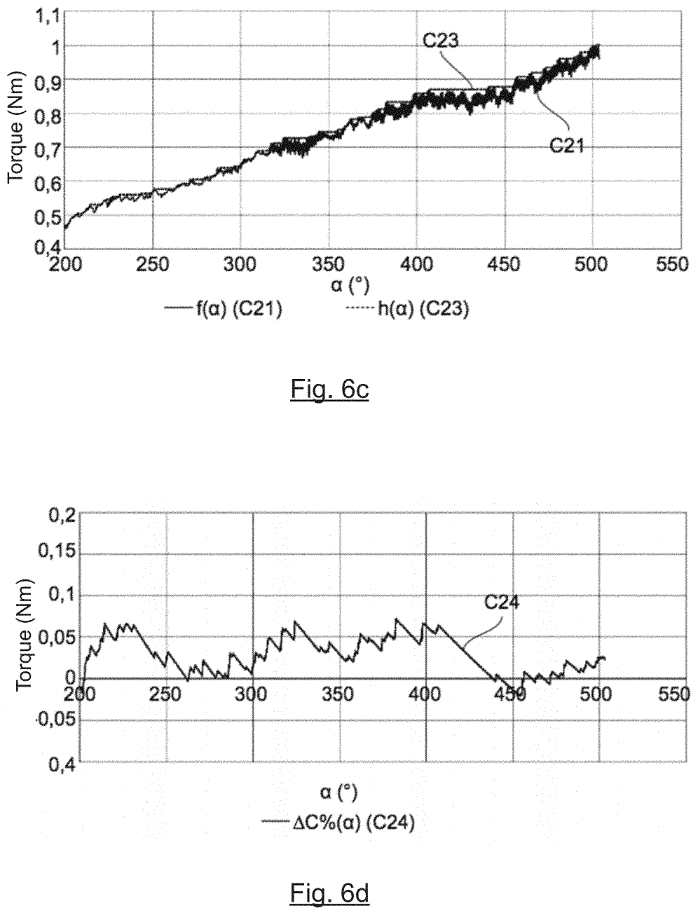

FIG. 6.1 illustrates an example of a curve C21 representing this first table.

At a second stage and identical to the first implementation, the controller 6 determines the theoretical characteristic of the screw, which is an image of the true characteristic. The result from this step is a series of values forming the second table, and expressing:

C_{caractéristique vraie}=g(α)

FIG. 6.2 illustrates an example of a curve C22 representing this second table, superimposed on the curve C21.

At a third stage and in a manner different from the first implementation, the controller 6 isolates the portion of the signal resulting from the disturbances generated by the tool. This third stage is sub-divided into several steps:

I] determining, from the torque table transmitted by the tool as a function of the angle, of a first relationship expressing the fact that the stoppage of the tool does not take account of the decreases in torque. The table thus determined is expressed as follows:

$$h ( α ) = {max}_{0 \leq x \leq α} f ( x )$$

With h(α) being the torque (Nm) computed by the controller 6 which expresses the fact that a stoppage of the tool cannot be activated on a torque value below a value previously attained during the tightening. As in the case of the previous method, the tool always stops at the level of a maximum.

FIG. 6.3 illustrates an example of a curve C23 representing this table, superimposed on the curve C21.

II] determining a second relationship which expresses the differences between the first relationship and the theoretical characteristic. In other words, this second relationship gives, as a function of the angle, the difference between the torque table computed at the previous step and the theoretical characteristic of the screw (second table, S2). This results in a series of values expressing:

ΔC=h(α)−g(α)

III] determining a third relationship obtained by standardizing the second relationship relative to the theoretical characteristic; this step consisting in taking the ratio between the difference and theoretical characteristic of the screw. This results in a series of values constituting the third table and expressing:

ΔC %(α)=(h(α)−g(α))/g(α)

FIG. 6d illustrates an example of a curve C24 representing this third table.

In a fourth stage, the dispersion and the deviation relative to the objective resulting from said part of the signal which itself results from the disturbances generated by the tool are computed. This step enables the computation of the dispersion and deviation relative to the tightening objective that are induced by all the disturbances.

The mean of this difference on the totality of the signal is first of all computed. This mean is representative of the deviation between the torque generated by the tool and the tightening torque objective. It can be expressed by the following equation:

$$\overline{x} = {C}_{consigne} - \frac{1}{n} {\sum }_{y = 1}^{n} Δ C \% ( y )$$

The mean standard deviation of this third relationship is then computed. This standard deviation is representative of the dispersion introduced by the torque measured by the tool. It can be expressed by the following equation:

$$σ = \frac{1}{\overline{x}} \times \sqrt{\frac{1}{n} {\sum }_{y = 1}^{n} {( Δ C \% ( y ) - {C}_{consigne} + \overline{x} )}^{2}}$$

where n here represents all the points of the measurement during the work of the tool.

Unlike the first implementation in which only one period is taken into account because they are all considered to be identical, the second implementation takes account of each oscillation. This second method has the advantage of considering disparities, if any, between the oscillations.

In a fifth stage, and similarly to the first implementation, the results of evaluation and an alert if necessary is/are sent out.

This second implementation is however appreciably less precise because it does not enable results to be obtained for each disturbance frequency, and therefore does not enable each component to be tested individually.

The present invention thus makes it possible especially to determine whether or not a tool is capable of carrying out the work asked of it, in real time and on the assembly line. The invention can also be used to make a visual determination of the results of the measurement, whether or not the work, a screwing operation for example, has been properly done. Since the values characterize the disturbances detected and computed during a job with the part produced, it is possible to carry out a posteriori quality control of the parts produced and thus raise questions about the quality of certain parts if it turns out that the amplitude of the disturbances has been too great.

The method of the invention makes it possible especially to provide, according to needs and applications, at least one of the following elements:
a warning as to whether the dispersion or the deviation with respect to the setpoint value of tightening operations no longer meets production requirements, this being the case possibly when the screwdriver is being used in production (quality/security aspect);
an estimation of the dispersion and a deviation relative to the setpoint value of the tightening operations by the screwdriver for the usual test stiffness values, this being the case possibly during a maintenance test (fast controls aspect);
the detection of an abnormal amplitude of disturbance of a component and the generation of a warning (diagnostic aspect).

The invention thus makes it possible, in particular:
to warn the user in real time about the incapacity of a screwdriver to accurately perform the work, for example during the use of the tool on an assembly line;
to speedily provide, in real time, an estimation of the dispersion and the deviation relative to the tightening objective;
to generate a warning if a component of the screwdriver gets abnormally deteriorated, especially to enable the tool assembler or the maintenance technician to identify the defective component or components.

Although the invention has been described through a certain number of detailed embodiments, the proposed method and the corresponding devices comprise different variants, modifications and improvements that shall be obvious to those skilled in the art, it being understood that these different variants, modifications and improvements are part of the scope of the invention, as defined by the following claims. In addition, different aspects and characteristics described here above can be implemented together, or separately, or else substituted for one another, and the set of the different combinations and sub-combinations of the aspects and characteristics form part of the scope of the invention. In addition, it can happen that certain devices described here above do not incorporate the totality of the modules and functions planned for the implementations described.

### 5.4 Embodiments of the Method of the Invention

As indicated here above, a minimum angle of rotation of 720° (at least two turns to analyze the low frequencies) of the output shaft is generally desirable. When a single screwing operation does not cover this minimum angular range, it is therefore desirable to take account of the measurement readings taken from two or more screwing operations.

The data obtained from these different screwing operations must then be combined, or concatenated, to implement the technique described here above and especially to build the tables described here above. This concatenation however cannot be implemented without preliminary processing, the technique described here above taking account of the periodicity of the signal represented by the measurements and processing operations.

Thus, the invention proposes a method for controlling a level of quality of screwing by a screwdriver relative to a predetermined screwing objective taking account of a series of data that are representative of the rise in torque of at least two screwing operations at a predetermined angular frequency. It comprises the following steps:
obtaining a sub-series of data for each of said screwing operations, corresponding to a sub-series of measurements;
optimized aggregation of said sub-series to form said series of data, comprising a step of elimination of data corresponding to a determined number of measurements according to a criterion of optimization of periodicity; and
analysis of said series of data, delivering said at least one piece of information representative of a dispersion and/or a deviation relative to said screwing objective, resulting from the disturbances induced by said screwdriver.

In other words, the concatenation, or aggregation, of data coming from two (or more) sub-series of measurements does not preserve all the available data, although the primary objective is to have a sufficient angular range available. On the contrary, certain pieces of data are eliminated, so that the signal resulting from the processing of the data preserved has characteristics of periodicity that are efficacious for determining the information on dispersion and/or deviation.

The purpose of this elimination, in substance, is to provide a final signal that is as periodic as possible or, in other words, it is that the link between the two signal portions, corresponding to two screwing operations taken into account, should be as linear as possible (i.e. that the slopes of the two signal portions, at the level of their junction, should be as close as possible to each other so that this junction is as “smooth” as possible, without introducing any sudden transition that would disturb the analysis).

Two embodiments are described here below.

### 5.4.1 First Embodiment of the Invention

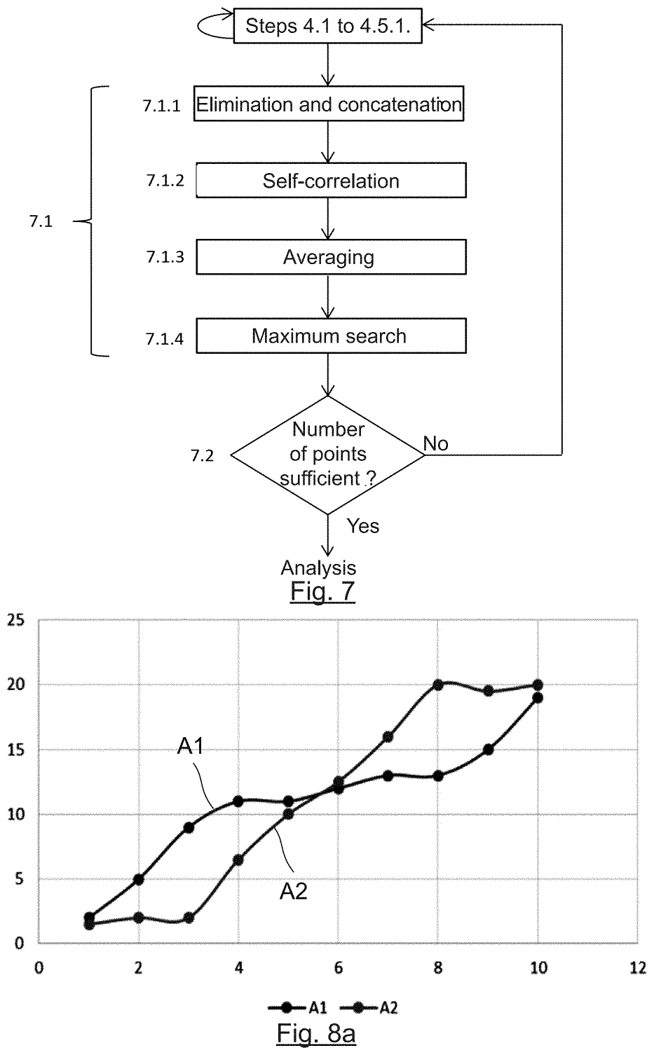

Referring to FIG. 7, a first embodiment shall now be described. FIG. 7 presents a flow chart of the main steps for implementing a method of control of a level of quality of screwing by a screwdriver, relative to a predetermined screwing objective, according to a third embodiment.

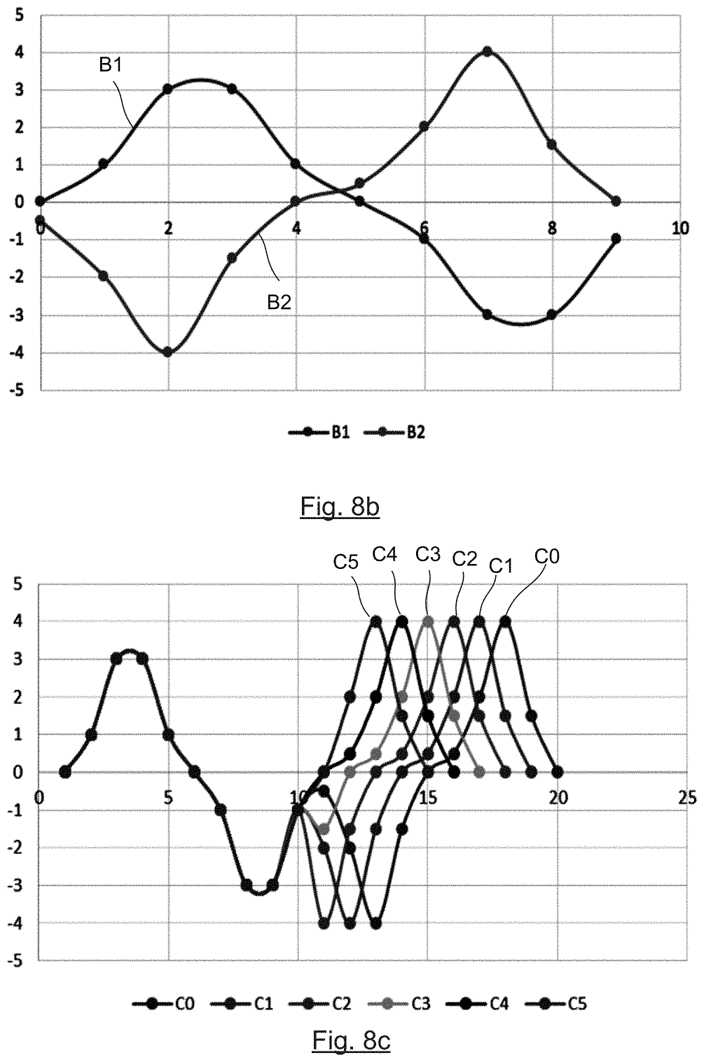

Certain steps of this first embodiment are besides illustrated further below through the curves represented in FIG. 8a, FIG. 8b and FIG. 8c.

More particularly, during the implementation of the step 4.3 (according to any one of the implementations mentioned here above in paragraph 5.3), a series of doublets that is representative of the rise in torque of the screwing of a first screw, screwed by the screwdriver of FIG. 1, is obtained (for example after implementing the steps 4.1 and 4.2 described here above). Each doublet comprises an angle value and a torque value. This means that a first table of values associated with the first screwing operation is constituted. The first table thus obtained is illustrated by the curve Al of FIG. 8a.

At the implementation of the step 4.4 (according to any one of the above implementations), a second table of values, associated with the first screwing operation, is determined from the first table of values. The second table of values presents the torque as a function of the angle and is representative of the true characteristic of the first screw.

At the implementation of the step 4.5.1 (according to any one of the implementations mentioned here above), a third table of values presenting the torque as a function of the angle and representative of the disturbance induced by the screwdriver during the rise in torque of the screwing of the first screw, is determined from the first and second tables. The third table associated with the first screwing operation thus obtained is illustrated by the curve B1 of FIG. 8b.

However, contrary to the two first implementations described here above, the steps 4.3 (for example after implementation of the steps 4.1 and 4.2 described here above), 4.4. and 4.5.1 are implemented for at least a second screwing of screws by the screwdriver. This means that the following are obtained: a first table of values associated with the second screwing operation (illustrated by the curve A2 of figure FIG. 8a), a second table of values associated with the second screwing operation, as well as the third table associated with the second screwing operation (illustrated by the curve B2 of FIG. 8b).

Indeed, the defects searched for in the measurements are related to the screwdriver. Thus, even when different screws are screwed, the defect is found in the series of measurements made during the different operations implemented for screwing screws. Thus, in order to be able to carry out a fine analysis of the measurements made, for example on the basis of sufficient number of measurement points, during a step 7.1, an optimized aggregation of the third table associated with the first screwing operation and the third table associated with the second screwing operation is implemented. Such an optimized aggregation comprises an elimination, from the third table associated with the second screwing operation, of a number of values that is determined according to a criterion of optimization of periodicity. A third candidate aggregated table is thus delivered at the end of the implementation of the step 7.1.

More particularly, at a sub-step 7.1.1, the third table associated with the first screwing operation and a truncated version of the third table associated with the second screwing operation, called a truncated third table, are concatenated so as to form an intermediate aggregated table. The truncated third table results from an elimination of a given number of successive values corresponding to angles of minimum amplitude among the values of the third table associated with the second screwing operation. In other words, it is the first values of the third table associated with the second screwing operation that are eliminated here. Besides, the elimination from the third table associated with the second screwing operation and the concatenation with the third table associated with the first screwing operation are repeated for different values of given numbers of eliminated values. Thus, a set of intermediate aggregated tables is obtained.

If we reconsider the example of the curves (and vectors of associated values) B1 and B2 of FIG. 8b representing the third tables associated respectively with the first and second screwing operation, the following formula is for example used to obtain the values of each intermediate aggregate table (the different intermediate aggregate tables are herein indexed by x).

$$∀ \times entier ∈ [ 0 ; \frac{{longueurB}_{2}}{2} ] , \\ ∀ a entier ∈ [ 1 ; longueur {B}_{1} + longueur {B}_{2} - x ] , \\ {C}_{x} ( a ) = \{ \begin{matrix}{B}_{1} ( a ) si a \leq longueur {B}_{1} \\ \begin{matrix}{B}_{2} ( a - longueur {B}_{1} + x ) si longueur {B}_{1} < \\ a < longueur {B}_{1} + longueur B 2 - x\end{matrix}\end{matrix}$$

(“entier” means “integer”; “longueur” means “length”; “si” means “if”)

The curves C0 to C5, corresponding to the different intermediate aggregated tables of the set of intermediate aggregated tables obtained, are represented by FIG. 8c.

In terms of numerical values, the values corresponding to the curves B1 and B2 are given in the following table:

| Échantillon | B1 | B2 |
|---|---|---|
| 1 | 0 | −0, 5 |
| 2 | 1 | −2 |
| 3 | 3 | −4 |
| 4 | 3 | −1, 5 |
| 5 | 1 | 0 |
| 6 | 0 | 0, 5 |
| 7 | −1 | 2 |
| 8 | −3 | 4 |
| 9 | −3 | 1, 5 |
| 10 | −1 | 0 |

The numerical values corresponding to the curves C0 to C5 are then given in the following table:

| Échantillon | C0 | C1 | C2 | C3 | C4 | C5 |
|---|---|---|---|---|---|---|
| 1 | 0 | 0 | 0 | 0 | 0 | 0 |
| 2 | 1 | 1 | 1 | 1 | 1 | 1 |
| 3 | 3 | 3 | 3 | 3 | 3 | 3 |
| 4 | 3 | 3 | 3 | 3 | 3 | 3 |
| 5 | 1 | 1 | 1 | 1 | 1 | 1 |
| 6 | 0 | 0 | 0 | 0 | 0 | 0 |
| 7 | −1 | −1 | −1 | −1 | −1 | −1 |
| 8 | −3 | −3 | −3 | −3 | −3 | −3 |
| 9 | −3 | −3 | −3 | −3 | −3 | −3 |
| 10 | −1 | −1 | −1 | −1 | −1 | −1 |
| 11 | −0, 5 | −2 | −4 | −1, 5 | 0 | 0 |
| 12 | −2 | −4 | −1, 5 | 0 | 0, 5 | 2 |
| 13 | −4 | −1, 5 | 0 | 0, 5 | 2 | 4 |
| 14 | −1, 5 | 0 | 0, 5 | 2 | 4 | 1, 5 |
| 15 | 0 | 0, 5 | 2 | 4 | 1, 5 | 0 |
| 16 | 0, 5 | 2 | 4 | 1, 5 | 0 | |
| 17 | 2 | 4 | 1, 5 | 0 | | |
| 18 | 4 | 1, 5 | 0 | | | |
| 19 | 1, 5 | 0 | | | | |
| 20 | 0 | | | | | |

(“Echantillon” means “sample”)

As an alternative, at the sub-step 7.1.1, the third table associated with the second screwing operation and a truncated version of the third table associated with the first screwing operation, called a third truncated table, are concatenated so as to form the intermediate aggregated table. More particularly, the third truncated table results from an elimination of a given number of successive values corresponding to angles of maximum amplitude among the values of the third table associated with the first screwing operation. In other words, it is the last values of the third table associated with the first screwing operation that are eliminated here.

Besides, the elimination from the third table associated with the first screwing operation and the concatenation with the third table associated with the second screwing operation are repeated for different values of the given number of eliminated values, thus delivering the set of intermediate aggregate tables in this alternative.

Returning to FIG. 7, at a sub-step 7.1.2, a self-correlation is implemented for each intermediate aggregated table of the set of intermediate aggregated tables previously obtained. As a result, a corresponding set of self-correlated intermediate aggregated tables is delivered.

If we reconsider the example of the curves (and associated vectors of values) C0 to C5 of FIG. 8c, the following formula is for example used to compute the self-correlation function g(y,x) of each intermediate aggregated table (y here is the argument of each self-correlation function, the different intermediate aggregated tables C0 to C5 being indexed by x):

$$∀ y entier ∈ [ 0 ; longueur Cx ] , \\ g ( y , x ) = \frac{{\sum }_{i = 0}^{( longueur Cx ) - y - 1} {C}_{x} ( i + y ) \times {C}_{x} ( i )}{( longueur Cx ) - y}$$

(“entier” means “integer”; “longueur” means “length”)

In practice, this operation consists in obtaining the sum of the multiplication, term by term, of the vector C_{X}(i) plus an offset version of the value y, C_{X}(i+y).

At a sub-step 7.1.3, each self-correlated intermediate aggregated table is averaged. Thus, a corresponding set of averaged values is delivered.

If we reconsider the example of the self-correlation functions g(y,x) here above, the following formula is for example used to obtain the averaged values in question:

$$h ( x ) = \frac{{\sum }_{j = 1}^{{G}_{x}} g ( j , x )}{{G}_{x}}$$

with Gₓ the number of values in the vector to be averaged. In terms of numerical values associated with the curves (and vectors of associated values) C0 to C5 of FIG. 8c, we thus obtain:

| x | 0 | 1 | 2 | 3 | 4 | 5 |
|---|---|---|---|---|---|---|
| h(x): | −4,778 | 2,236 | 2,417 | 3,147 | 3,953 | 3,95 [symbol] |

[symbol]

indicates data missing or illegible when filed

Thus, an intermediate aggregate table, for which the corresponding averaged value is the maximum among the averaged values, is selected as being the third candidate aggregate table according to the criterion of optimization of periodicity. Thus, the third candidate aggregated table corresponds to the intermediate aggregated table presenting the greatest regularity (in terms of self-correlation) among the different tables of the set of intermediate aggregated tables. Thus, the results of an analysis based for example on an implementation of a Fourier transform are improved, the discontinuities of the analyzed table being minimized. In the above example, the third candidate aggregated table is thus the curve C4 corresponding to x=4.

Besides, when several intermediate aggregated tables have an averaged value that is the same maximum value among the set of averaged values, an intermediate aggregated table corresponding to the elimination of a minimum number of successive values (during the implementation of the elimination of values from the third table associated with the second screwing operation) is selected from among the intermediate aggregated tables in question as being the third, or selected, candidate aggregated table according to the criterion of optimization of periodicity. Thus, a maximum number of values is obtained in the third candidate aggregated table so as to enable a better resolution of analysis of the table in question.

At a step 7.2, the total number of values of the third candidate aggregated table is tested, for example by comparison with a predetermined threshold. For example, it is decided that the third candidate aggregated table is the third aggregated table when the total number of values of the third candidate aggregate table is above a predetermined threshold. Thus, the number of values of the third aggregated table is considered to be sufficient to be able to obtain an efficient resolution of analysis of the defects of the screwdriver.

As an alternative, when the total number of values of the third candidate aggregated table is below the predetermined threshold, the steps 4.3 (for example after implementation of the steps 4.1 to 4.2 described here above), 4.4 and 4.5.1 (according to any one of the implementations mentioned here above) are again implemented for a new screwing of screws by the screwdriver. A new third corresponding table is thus delivered. On this basis, the step 7.1 of optimized aggregation (according to any one of the above-mentioned embodiments) is again applied to the third candidate aggregated table and the new third table. A new third candidate aggregated table is thus delivered. Thus, when the number of values of the third aggregated table is not sufficient to be able to carry out a fine analysis of the defects of the screwdriver, a new optimized aggregation is implemented iteratively in order to obtain a number of values sufficient for a fine analysis of the results.

In certain embodiments, the new candidate aggregated table is the object of a new test on the number of values that it contains according to a new implementation of the step 7.2 as described here above.

In certain embodiments, the step 7.2 is not implemented and the analysis is done routinely on the third candidate aggregated table obtained from the optimized concatenation of values measured during a predetermined number of screwing operations (for example two screwing operations, three screwing operations, etc.). In these embodiments, the third candidate aggregate table, obtained after the implementing of the step 7.1 for a number of times corresponding to the predetermined number in question, is routinely the third aggregate table.

Returning to FIG. 7, the third aggregate table is analyzed so as to deliver at least one piece of information representing a dispersion and/or a deviation relative to the screwing objective, resulting from disturbances induced by the screwdriver. For example, such an analysis is implemented according to the technique described here above with reference to the first implementation (cf. steps 4.5.2, 4.5.3, 4.5.4, 4.5.5, 4.5.6, 4.6, according to any one of the implementations mentioned here above) and second implementation of the method of paragraph 5.3.

### 5.4.2 Second Embodiment of the Invention

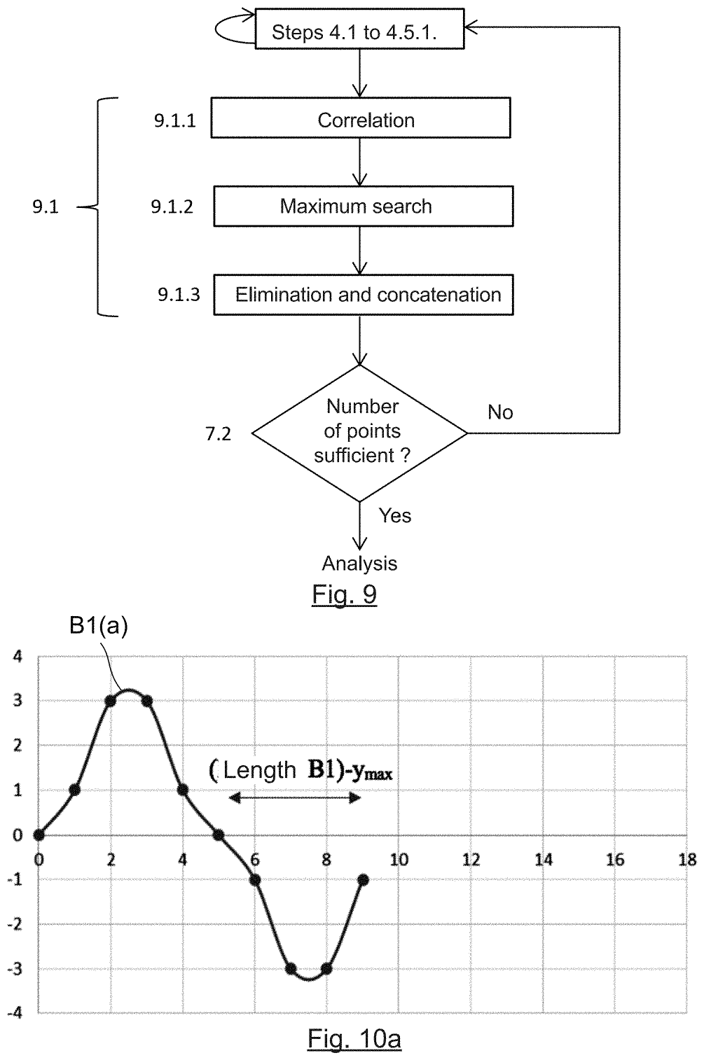

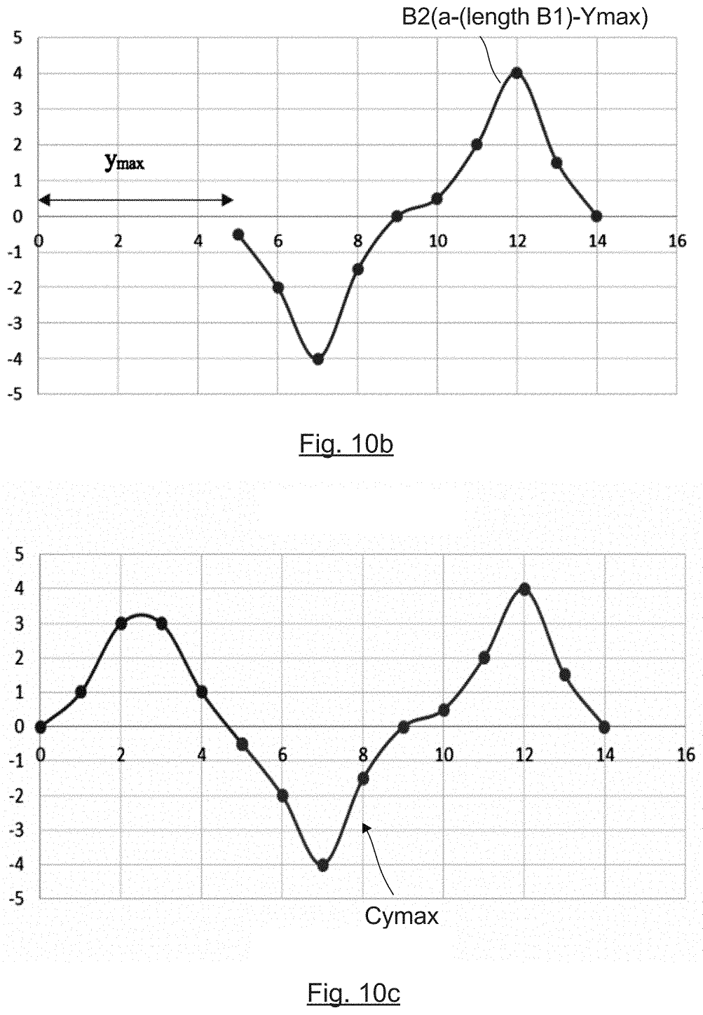

Referring to FIG. 9, a second embodiment shall now be described. FIG. 9 presents a flowchart of the main steps for the implementing of a method of control of a level of quality of screwing by a screwdriver, in relation to a predetermined screwing objective, according to a fourth example of an embodiment. Certain steps of this second embodiment are besides illustrated further below via the curves represented in FIG. 10a, FIG. 10b and FIG. 10c.

The first embodiment described here above gives very good results. However, the computation of the self-correlation is fairly costly in terms of computation load as well as memory. The second embodiment is used to limit the load of computations at the cost of slightly less satisfactory results. Such results are however sufficient in many practical cases.

Just as in the first embodiment described here above, according to the second embodiment, the steps 4.3 (for example after implementation of the steps 4.1 and 4.2), 4.4 and 4.5.1 are implemented for at least one first screwing and one second screwing of screws by the screwdriver. Thus, two first tables of values associated respectively with the first and second screwing operations, two second tables of values associated with the first and second screwing operations and two third tables of values associated with the first and second screwing operations are obtained.

In order to be able to carry out a fine analysis of the measurements made, for example on the basis of a sufficient number of measurement points, at a step 9.1, an optimized aggregation of the third table associated with the first screwing operation and the third table associated with the second screwing operation is implemented. Such an optimized aggregation comprises an elimination, from the third table associated with the second screwing operation, of a number of values that is determined according to a criterion of optimization of periodicity. A third candidate aggregated table is delivered at the end of the implementation of the step 9.1

To this end, during a sub-step 9.1.1, a correlation is computed between, on the one hand, the third table associated with the first screwing operation and, on the other hand, the third table associated with the second screwing operation. A correlation function is thus delivered.

If we reconsider the example of the curves (and vectors of associated values) B1 and B2 of FIG. 8b described here above and representing the third tables associated respectively with the first and second screwing operations, the following formula is for example used to obtain the correlation function in question (y here is the argument of the correlation function):

$$g ( y ) = \frac{{\sum }_{i = 0}^{( longueur {B}_{1} ) - y - 1} {B}_{1} ( i + y ) \times {B}_{2} ( i )}{( longueur {B}_{1} ) - y}$$

(“longueur” means “length”)

According to such a formula, the length of B1 must be smaller than or equal to the length of B2. In practice, the roles of B1 and B2 can be interchanged if necessary in order to satisfy such a condition.

At a sub-step 9.1.2, a value with an argument ymax (corresponding in practice to an angle of rotation of the screwdriver) maximizing the correlation function g(y) is determined. The criterion of optimization of periodicity corresponds to the case of elimination, in the third table associated with the first screwing operation, of a successive number of values, called an optimized number, as a function of the argument value maximizing the correlation function g(y).

Besides, when several values of arguments maximize the correlation function g(y), the optimized number is a function of a maximum value of the argument among the values of the arguments maximizing the correlation function g(y). Thus, a maximum number of values is obtained in the third aggregated table so as to enable a better resolution of analysis of the table in question.

In variants, the search for the values of arguments maximizing the correlation function g(y) is limited to the interval

$$y ∈ [ \frac{longueur {B}_{1}}{2} ;$$

longueur B1 [(“longueur” means “length”) so as to eliminate at most only half of the values of the third table associated with the first screwing operation.

At a sub-step 9.1.3, a truncated version of the third table associated with the first screwing operation and the third table associated with the second screwing operation are concatenated so as to deliver a third candidate aggregated table. The third truncated table results from an elimination, from the third table associated with the first screwing operation, of the optimized number of successive values corresponding to arguments of maximum amplitude among the values of the third table associated with the first screwing operation. In other words, it is the last values of the third table associated with the first screwing operation that are eliminated here.

For example, if we reconsider the example of the curves (and vectors of associated values) B1 and B2 of FIG. 8b, the third candidate aggregated table corresponds to the curve (and to the vector of associated values) Cymax defined by:

$${C}_{{y}_{max}} ( a ) = \{ \begin{matrix}{B}_{1} ( a ) si a \leq ( longueur {B}_{1} ) - {y}_{max} \\ {B}_{2} ( a - ( longueur {B}_{1} ) - {y}_{max} ) sinon\end{matrix}$$

(“si” means “if”; “longueur” means “length”; “sinon” means “else”)

The different corresponding curves, i.e. B1(a), B2(a-(length B1)-Ymax) and Cymax are represented respectively in FIG. 10a, FIG. 10b and FIG. 10c.

The present second embodiment also comprises the step 7.2 (according to any one of the embodiments mentioned here above) for testing the total number of values of the third candidate aggregated table and/or analysis (according to any one of the above embodiments) as described here above with reference to the first embodiment of the method according to the invention.

In certain embodiments, the step 7.2 is not implemented and the analysis is done routinely on the third candidate aggregated table obtained from the optimized concatenation of values measured during a predetermined number of screwing operations (for example two screwing operations, three screwing operations, etc.). In these embodiments, the third candidate aggregate table, obtained after the implementing of the step 9.1 for a number of times corresponding to the predetermined number in question, is routinely or systematically the third aggregated table.

1. A method for controlling a level of quality of screwdriving by a screwdriver relative to a predetermined screwdriving objective, the method being performed by the screwdriver and comprising:
obtaining, at a predetermined angular frequency, a series of doublets that is representative of the rise in torque of the screwdriving of at least one screw screwed in by said screwdriver, constituting a first table of values, each doublet comprising an angle value and a torque value;
determining, from said first table of values, a second table of values presenting the torque as a function of the angle, and representative of the true characteristic of the at least one screw;
determining a third table of values presenting the torque as a function of the angle and representative of the disturbances induced by said screwdriver during the rise in torque of the screwdriving of at least one screw, on the basis of the first and second tables,
wherein said obtaining a series of doublets, determining a second table and determining a third table are implemented for at least one first screwdriving and one second screwdriving of screws by said screwdriver, delivering at least two corresponding third tables, called third unit screwdriving tables;
performing an optimized aggregation of at least two of said third unit screwdriving tables, comprising elimination, in at least one of said third unit screwdriving tables, of a number of values that is determined according to a criterion of optimization of periodicity, said optimized aggregation delivering a third candidate aggregated table; and
analyzing a third aggregated table taking account of said third candidate aggregated table, delivering at least one piece of information representative of a dispersion and/or a deviation relative to said screwdriving objective, resulting from disturbances induced by said screwdriver.

2. The method according to claim 1 wherein said optimized aggregation comprises a concatenation of, a third table of a first screwdriving operation and of a truncated version of a third table of the second screwdriving operation, called a third truncated table, delivering an intermediate aggregated table
said third truncated table resulting from an elimination, in said third table of the second screwdriving operation, of a given number of successive values corresponding to angles of minimal amplitude among the values of said third table of the second screwdriving operation, said elimination, in said third table of the second screwdriving operation, and said concatenation repeated for different values of the given number delivering a set of intermediate aggregated tables comprising said third candidate aggregated table.

3. The method according to claim 1 wherein said optimized aggregation comprises a concatenation of, a third table of a first screwdriving operation and a truncated version of a third table of the second screwdriving operation, called a third truncated table, delivering an intermediate aggregated table,
said third truncated table resulting from an elimination, in said third table of the first screwdriving operation, of a given number of successive values corresponding to angles of maximum amplitude among the values of said third table of the first screwdriving operation,
said elimination, in said third table of the first screwdriving operation, and said concatenation being repeated for different values of the given number delivering a set of intermediate aggregated tables comprising said third candidate aggregated table.

4. The method according to claim 2 wherein said optimized aggregation comprises:
a self-correlation of each intermediate aggregated table of said set of intermediate aggregated tables delivering a corresponding set of self-correlated intermediate aggregated tables;
an averaging of each of said self-correlated intermediate aggregated tables delivering a corresponding set of averaged values; and
selecting an intermediate aggregated table, the corresponding averaged value of which is maximal among said averaged values, as being said third candidate aggregated table according to said criterion of optimizing of periodicity.

5. The method according to claim 4 wherein, in response to several intermediate aggregated tables, called candidate intermediate aggregated tables, having an averaged value of a same maximum value among said averaged values, an intermediate aggregated table corresponding to the elimination of a minimum number of successive values, during the implementation of said elimination in said third table of the second screwdriving operation, is selected from among said candidate intermediate aggregated tables as being the third candidate aggregated table according to said criterion of optimization of periodicity.

6. The method according to claim 1 wherein said optimized aggregation comprises:
correlating between said third table of the first screwdriving operation and said third table of the second screwdriving operation, delivering a correlation function; and
determining at least one angle value maximizing said correlation function, said criterion of optimization of periodicity corresponding to the elimination, in said third table of the first screwdriving operation, of a number of successive values, called an optimized number, taking account of a value of an angle among said value or values of angles maximizing said correlation function.

7. The method according to claim 6 wherein, when several angle values maximize said correlation function, said optimized number is a function of a maximum value of an angle among said values of angles maximizing said correlation function.

8. The method according to claim 6 wherein said optimized aggregation comprises a concatenation between a truncated version of said third table of the first screwdriving operation, called a third truncated table and said third table of the second screwdriving operation, said concatenation delivering a third candidate aggregated table,
said third truncated table resulting from an elimination, in said third table of the first screwdriving operation, of said optimized number of successive values corresponding to angles of maximum amplitude among the values of said third table of the first screwdriving operation.

9. The method according to claim 4 comprising testing the total number of values of said third candidate aggregated table, and deciding that said third candidate aggregated table is said third aggregated table when said total number of values of said third candidate aggregated table is above a predetermined threshold.

10. The method according to claim 4 comprising, when said total number of values of said third candidate aggregated table is below said predetermined threshold:
a new implementation of said obtaining a series of doublets, determining a second table and determining a third table for a new screwdriving of screws by said screwdriver, delivering a corresponding new third table; and
a new implementation of said optimized aggregation between said third candidate aggregated table and said new third table, delivering a new candidate aggregated table.

11. A non-transitory computer-readable medium comprising a computer program stored thereon comprising program code instructions for carrying out method for controlling a level of quality of screwdriving by a screwdriver relative to a predetermined screwdriving objective, when said program is executed by a microprocessor and/or on a computer, the method being performed by the screwdriver and comprising:
obtaining, at a predetermined angular frequency, a series of doublets that is representative of the rise in torque of the screwdriving of at least one screw screwed in by said screwdriver, constituting a first table of values, each doublet comprising an angle value and a torque value;
determining, from said first table of values, a second table of values presenting the torque as a function of the angle, and representative of the true characteristic of the at least one screw;
determining a third table of values presenting the torque as a function of the angle and representative of the disturbances induced by said screwdriver during the rise in torque of the screwdriving of at least one screw, on the basis of the first and second tables,
wherein said obtaining a series of doublets, determining a second table and determining a third table are implemented for at least one first screwdriving and one second screwdriving of screws by said screwdriver, delivering at least two corresponding third tables, called third unit screwdriving tables;
performing an optimized aggregation of at least two of said third unit screwdriving tables, comprising elimination, in at least one of said third unit screwdriving tables, of a number of values that is determined according to a criterion of optimization of periodicity, said optimized aggregation delivering a third candidate aggregated table; and
analyzing a third aggregated table taking account of said third candidate aggregated table, delivering at least one piece of information representative of a dispersion and/or a deviation relative to said screwdriving objective, resulting from disturbances induced by said screwdriver.

12. A screwdriver comprising:
at least one rotating member capable of generating disturbances on the torque applied to a screw;
a processor configured to control a level of quality of screwdriving, relative to a predetermined screwdriving objective, implemented during the screwdriving of at least one screw wherein the controlling comprises:
obtaining, at a predetermined angular frequency, a series of doublets that is representative of the rise in torque of the screwdriving of at least one screw, constituting a first table of values, each doublet comprising an angle value and a torque value;
determining, from a first table of values, a second table of values presenting the torque as a function of the angle, and representative of a true characteristic of the at least one screw;
determining a third table of values presenting the torque as a function of the angle and representative of the disturbances induced by said screwdriver during the rise in torque of the screwdriving of at least one screw, on the basis of the first and second tables,
wherein the obtaining a series of doublets, for determining a second table and for determining a third table are implemented for at least one first screwdriving and one second screwdriving of screws by said screwdriver, delivering at least two corresponding third tables, called third unit screwdriving tables;
optimized aggregation of said third unit screwdriving tables, comprising climinating, in at least one of said third unit screwdriving tables, a number of values that is determined according to a criterion of optimization of periodicity, said optimized aggregation delivering a third candidate aggregated table; and
analysis of analyzing a third aggregated table taking account of said third candidate aggregated table, delivering at least one piece of information representative of a dispersion and/or a deviation relative to said screwdriving objective, resulting from disturbances induced by said screwdriver.
